(19) United States
(12) Patent Application Publication
(10) Pub. No.: US 2003/0066762 A1
(43) Pub. Date: Apr. 10, 2003

(54) Amperometric probe

(76) Inventors: Alexander Friedenberger, Berlin (DE); Tjalf Pirk, Berlin (DE); Hans-Henrich Stiehl, Potsdam (DE)

Correspondence Address: DORSEY & WHITNEY LLP, INTELLECTUAL PROPERTY DEPARTMENT, 50 SOUTH SIXTH STREET, MINNEAPOLIS, MN, 55402-1498, US

(21) Appl. No.: 10/234,435

(22) Filed: Sep. 3, 2002

(30) Foreign Application Priority Data
Sep. 3, 2001 (DE) DE 10144094.4

(51) Int. Cl. G01N 27/26

(52) U.S. Cl. 205/775; 204/412

(57) ABSTRACT

In a method and apparatus of an amperometric probe for characterization of the electrostatic state in gases containing ions, by means of the electrical space potential and/or the density of positive and negative ions, in particular in gases flowing around a sensor (1) with an applied electrical potential (5, 6), and emitting ions to the sensor; an electrical circuit (2) is provided for detecting the measured sensor curents; a current comparison unit (3) follows the current detection and monitors that the sensor currents are within the permissible value range in terms of their mathematical sign and their magnitude, applies a first sensor potential and detects the associated sensor current, as well as subsequently applies a second sensor potential and carries out an adaptation process in such a way that the detected second sensor current has the same mathematical sign as the first sensor current; the space potential and the density of the ions of one polarity are determined in a calculation unit (4); and, with an appropriately selected third sensor potential, a third sensor current whose mathematical sign is the opposite of that of the first two sensor currents is then detected, and the density of the ions of the other polarity is then also determined. The method and apparatus provide for the effective cross section of the probe to be evaluated in addition to the assessment of the physical resolution of the measurement values, and for the measurement to be carried out with high spatial resolution and with little disturbance to the surrounding area.

### FIELD OF THE INVENTION

The invention relates to a method and an apparatus for measuring the space potential and ion densities in a gas, using a probe.

The measurement of space potentials and ion densities is of interest in a wide range of applications. The occurrence of ions is normally associated with the occurrence of space potentials which can themselves influence the measurement method. It may therefore be highly useful to achieve a detailed description of the electrostatic state of the gas by means of physical variables, using a single method. Applications for this exist in science, research and development, as well as there being numerous, widely scattered, practical technical applications. These include:

the characterization of the electrostatic state of gas plasmas and the determination of ion mobilities,

the checking of electret filters,

the monitoring of the air ion content in rooms with ionizing radiation,

the measurement and control of combustion processes and emissions from engines,

the deliberate influencing of plant and bacteria growth by the content of air ions,

the monitoring of disinfection and sterilization processes with ions for foodstuffs and appliances,

the monitoring of the effect of the electrical environment as influenced by the ion content of the air, and by the space potential, on human wellbeing in enclosed rooms,

the monitoring of the effect of the influence of the ion content in the air and the space potential on animal husbandry,

the meteorological characterization of the electrical air state, and

the monitoring of the neutralization of electrostatic charges that cause damage by air ionization during the manufacture, for example, of electrical components in clean rooms.

In this case, the invention is intended to be used not only for measuring previously defined objective physical variables, but also for controlling ion sources in order to produce predetermined ion densities in a gas.

### PRIOR ART

A probe for measurement of electrons in a thermal plasma, for example in the interior of an arc or of a rocket motor, is disclosed in DE-158 9836A. A voltage is applied to this probe, and the electron density and electron temperature are deduced from the current flowing via the plasma and the probe.

JP-2000124204A relates to a probe for measuring ions in a plasma which is produced in a discharge. The probe is connected successively to a positive potential and a negative potential with respect to the earth potential, and saturation currents are measured in the process.

DE 41 123 02 A1 relates to an electrochemical cell having a solid electrolyte for determining the partial pressure of a gas.

These three examples from the prior art cannot easily be used in the applications mentioned initially. This is because they relate specifically to measurements in thermal plasmas and autonomous discharges, where sensor currents are caused not only by ions but also by electrons, and where the effective cross section of the sensor differs from that in the initially mentioned applications owing to the different conditions for the gas flow, space potential and ion densities.

A commercially available “Charge Plate Monitor” (CPM) is used internationally as the standard test equipment for one of the applications mentioned initially, namely for describing the effect of air ionizers for the acceptance, testing and maintenance of systems, for example for ultrapure manufacture of microstructures of electronic components in clean rooms. As specified in the American Standard ANSI/EOS/ESD-S3.1-1991, worked up by the EOS/ESD Association [Electrical Overstress/Electrostatic Discharge Association Inc.], Rome, N.Y., USA, this appliance makes it possible to determine the decay times of an open, electrically charged, square capacitor plate as a measure of the ion density in a flowing gas

The capacitor plate has an edge length of 150 mm and a capacitance of 20 pF, and its potential is sampled without making contact, by means of a Feldmühle sensor. The decay time is defined by the discharge duration of the capacitor plate from a voltage 1000 V to a value of 100 V. Furthermore, the CPM is intended to make it possible to determine the space potential in that the plate is now made to float in terms of potential, and is thus intended to assume the space potential of the gas flowing around it, with the potential of the plate in this case as well being sampled by a Feldmühle sensor with a resolution of, for example, one volt. CPM thus allows measurement of space potentials, but does not make it possible to indicate ion densities, since no expression is known to describe the physical relationships between the ion densities and the measured decay time. However, the decay time is regarded as an empirical value, described by a standard convention, for ion densities.

Furthermore, an apparatus for measuring ions in a gas (MONION) using a spherical sensor has already been described in DE 42 31 905 C2, which is located in the laminar flow of a gas containing ions and to which three fixed potentials with a different mathematical sign are applied, one of which has the value zero. The cited patent specification relates to theoretical investigations by Riecke (Riecke, Eduard, Beiträge zu der Lehre von der Luftelektrizität [Articles relating to the teaching of air electricity]; Physics Annals (4) 12, 52-84, 1903).

An equation which is derived from Riecke's theory, the simple Riecke formula,

−i(+)=4πerk⁺n⁺U⁻ −i(−)=4πerk⁻n⁻U⁺ (1a,b)

indicates that the sensor currents are proportional to the ion density and to the sensor potential (equation 1), thus allowing direct calculation of the ion densities, using the following variables:

n⁺, n⁻ ion densities calculated using the simple Riecke formula

i(+), i(−) sensor currents with a positive and negative mathematical sign, respectively

i (0) currents for a sensor potential of 0 V

e elementary charge

U⁺, U⁻ positive or larger main sensor potential, negative or smaller main sensor potential

k⁺, k⁻ mobility of positive and negative ions

r radius of the Riecke's sphere

The negative mathematical sign in front of the sensor currents i(+) and i(−) also takes account of the fact that the sensor potential in each case has the opposite mathematical sign to the sensor current.

The Problem on Which the Invention is Based

New experiments have been carried out to determine ion densities in gases. These experiments have shown that the teaching relating to this art as contained in the German document is incomplete. The simple Riecke formula as stated there, for the sensor current based on equation (1), first does not take account of the considerable influence of space potentials on the detection of sensor currents, and thus leads to incorrect results in the evaluation of ion densities from the sensor currents. This does not recognize the fact that the prevailing space potentials must also be taken into account in the choice of the sensor potentials, and this is impossible using a measurement apparatus with fixed sensor potentials. The document claims that high spatial resolution of the measurement values is achieved, without stating any corresponding teaching relating to this art. Furthermore, the CPM, with its potentiostatic method, assesses space potentials differently to the amperometric probe according to the invention. The discrepancy that exists is caused primarily by the fact that the known teaching relating to the art is not derived from a closed description of the relationship of the physical variables evaluated in the measurement.

### SUMMARY OF THE INVENTION

The present invention is based on the object of avoiding the described disadvantages in the prior art.

This object is solved by a method and a device according to the independent claims. The dependent claims relate to preferred embodiments of the invention.

A physical description of the relationships between the sensor currents in the amperometric probe and the variables to be measured, as well as the operating parameters, allows suitable method steps to be derived for determining the measurement variables, and to describe appropriate functional groups of the measurement apparatus. In this case, the electrostatic state variables comprising the space potential and ion densities can be determined while taking into account the interaction between them. The following description will first explain how the corresponding solution approach is derived by theoretical analyses, and will then describe its reduction to practice in connection with preferred embodiments which confirm the theoretical analyses by measurements.

Solution Approach for the Described Problem

The theoretical analyses in the cited original work by Riecke are indicated by the representation of the motion lines of ions around a sphere at the potential U, in FIG. 1. The motion lines are calculated in the case of a laminar and parallel gas flow at a velocity v>0.1 μm/s. All the ions of the same polarity as the sphere potential are carried past the sphere, as shown by the dashed motion lines, in conjunction with the electric field and the gas flow; even the ions which move on the motion line D do not touch the sensor surface. This effect of ion scatter avoids diffusion potentials, and the sensor can measure sensor currents initiated by positive and negative ions, in each case independently of the density of the ions of opposite polarity. Sensor currents with a positive mathematical sign thus represent the density of positive ions, and negative sensor currents represent the density of negative ions. All the ions of the opposite polarity to the sphere potential and which move in a circular cross section with diameter AD in the region of the cross section which is not disturbed by the shape or by the potential of the sensor are sensed by the sensor. The sensor currents which occur in this case and can be associated with the density of the positive and negative ions are indicated in equation (1). The corresponding circular effective cross sections can be specified, according to Riecke, as

$${f}^{+} = \frac{- 4 π \cdot {k}^{+} r \cdot {U}^{-}}{v} ; {f}^{-} = \frac{4 π \cdot {k}^{-} r \cdot {U}^{+}}{v} \qquad \text{(2a,b)}$$

where

f⁺, f⁻ is the effective cross section of the spherical sensor for positive and negative ions, respectively

v is the velocity of the gas in the undisturbed laminar flow field.

The relationships illustrated in FIG. 1 suggest the following extension of the representation by Riecke in equations (1) and (2):

the formation of the effective cross section is governed by the potential which acts in the space between the sphere and the undisturbed flow, rather than by the potential on the sphere. Existing space potentials—for example caused by the ions themselves—must be taken into account

the formation of the effective cross section AC is governed less by a sharp contour of the spherical shape at the location of the sensor than by the effect of the sensor surface having a three-dimensional shape in the space between the sensor and the undisturbed flow.

The analyses relating to the sensor potential thus lead to the extended Riecke formula, which, instead of the sensor potentials U⁺ and U⁻, introduces effective sensor potentials into equations (1) and (2), taking account of space potentials Uᵣ, that is to say (U⁺−Uᵣ) and (U⁻−Uᵣ).

The extended Riecke formulae take account of the analysis relating to the configuration of a three-dimensional sensor head by introducing the effective sensor radius R instead of the radius r, which characterizes the spherical shape of the sensor according to Riecke. The introduction of R is based on the idea that the formation of the electric field between the sphere and the undisturbed flow is based primarily and critically on the size of the sensor surface, and only secondly on its fine structure. This is because, in the case of two-dimensional sensors such as the capacity plates of the CPM, the electric field decreases with 1/d, that is to say in inverse proportion to the distance d in open space. For three-dimensional sensors in contrast, it decreases with 1/d², that is to say in inverse proportion to the square of the distance from its geometric centre. The extended theory from Riecke therefore also applies to three-dimensional sensor bodies with similarly high symmetry such as that of the sphere, for example for three-dimensional sensor bodies whose surface is separated from a centre point within a tolerance band of +/−15%, without any sharp sudden changes in the distances, and includes the use of a sphere. The effective radius R of a three-dimensional open sensor such as this, in conjunction with a capacitive measurement bridge, expediently makes it possible to define the formula for the capacitance of a sphere by the equation

R=C/4πε₀ (3)

with the following variables being used:

R effective radius of the three-dimensional sensor head

C capacitance of the three-dimensional sensor in free space

ε₀ dielectric constants

The effective radius R, but not its capacitive measurement according to equation (3), is thus used in the subsequent computation process in order to simplify the representation of the influence of the space potentials.

Riecke's theoretical analyses supplemented in this way lead to the extended Riecke formulae for the effective cross section and sensor current

$${F}^{+} = \frac{- 4 π \cdot {k}^{+} \cdot R \cdot ( {U}^{-} - {U}_{r} )}{v} ; {F}^{-} = \frac{4 π \cdot {k}^{-} \cdot R \cdot ( {U}^{+} - {U}_{r} )}{v} \qquad \text{(4a,b)}$$

−i(+)=4πeRk⁺N⁺(U⁻−Uᵣ); −i(−)=4πeRk⁻N⁻(U⁺−Uᵣ) (5a,b)

where:

N⁺, N⁻ are densities of positive and negative ions, determined using the extended Riecke formula and taking into account the influence of space potentials,

Uᵣ is an initially unknown potential in space,

F⁺, F⁻ are effective cross sections determined using the extended Riecke formula.

Equation (4) describes the influence of the space potential on the effective cross section, and equation (5) describes the effect of the space potential and of the ion densities on the sensor current. Equation (a) applies to a positive sensor current which occurs by absorption of positive ions with a negative effective sensor potential and equation (b) applies to a negative sensor current which occurs by absorption of negative ions with a positive effective sensor potential. The negative mathematical sign in each case takes account of the fact that the sensor currents have the opposite polarity to the sensor potentials.

A first major feature of the use of the extended Riecke formula is that the limit on the applicability range of the basic equation (5) must be borne in mind. The mathematical sign of the sensor current which is measured using equation (a) and is initiated by positive ions when a negative effective sensor potential is applied must always be possible in order that the specific ion mobility k⁺ is also associated correctly. If the magnitude of the space potential Uᵣ exceeds that of the sensor potential, however, the effective sensor potential, which has been introduced above and is effective in space, changes its mathematical sign, and the probe detects the current resulting from ions with an opposite mathematical sign, in an incorrect manner. The sensor currents which are associated with the effective sensor potentials U⁺−Uᵣ and U⁻−Uᵣ which act in space have a limited permissible range of values:

i(+)>0 for U⁻−Uᵣ<0; i(−)<0 for U⁺−Uᵣ>0 (6a,b)

It follows from this that the following relationships must exist for the space potential:

U⁻<Uᵣ for positive ions; Uᵣ<U⁺ for negative ions (7a,b).

The definition range for space potentials is accordingly in each case restricted on one side. In order to determine ion densities, according to Riecke, negative sensor potentials must be used for positive ions, and positive sensor potentials must be used for negative ions. The permissible value range for the sensor currents thus results in a restricted definition range for the space potential of U⁻<Uᵣ<U⁺ for measurement of the density of ions of both mathematical signs.

The extended Riecke formula (5) is two equations with two measured sensor currents and with three unknown variables N⁺, N⁻ and Uᵣ. All three variables can be determined by measuring a further sensor current, with a third sensor potential. A sensor potential is referred to as the auxiliary potential U(h), in order to distinguish it from the main sensor potentials U⁺ and U⁻. Auxiliary potentials are associated with the main sensor potentials based on the mathematical sign of the sensor current associated with them. If a positive sensor current i(h+) occurs, the potential is allocated as U(h−) to the lower main sensor potential U⁻, and if a negative sensor current i(h−) occurs, the potential is allocated as U(h+) to the larger main sensor potential U⁺. The auxiliary potentials U(h−) and U(h+) differ from U⁻ and U⁺, respectively, in that the magnitudes are intended to be less than i(+) and i(−), respectively, in accordance with an organization convention i(h+) and i(h−), which is used here arbitrarily. The permissible value range for the associated sensor currents is restricted in the same way as the sensor currents associated with the main sensor potentials. The sensor currents i(h+) which are initiated on detection of positive ions with an auxiliary potential U(h−) are positive. An analogous situation applies to the detection of negative ions. The corresponding conditions for the permissible value range of the sensor currents and the corresponding definition range, which is bounded by auxiliary potentials, of the space potentials are:

i(h+)>0 for U(h−)−Uᵣ<0; i(h−)<0 for U(h+)−Uᵣ>0 (8ab)

Uᵣ>U(h−) and U⁻<U(h−)<U⁺; Uᵣ<U(h+) and U⁻<U(h+)<U⁺ (9ab)

Observing this restriction, the main sensor potentials U⁺, U⁻ and the auxiliary potentials U(h−), U(h+) may in principle assume any desired values within a very wide range. High values of the effective sensor potentials (U⁻−Uᵣ) or (U⁺−Uᵣ) and (U(h−)−Ur) or U(h+)−Uᵣ>0 lead to high sensor currents and thus, corresponding to equation (5), increase the sensitivity of the measurement method for ion densities. In contrast, small space potentials can be resolved only if the sensor potentials are in the same order of magnitude as Uᵣ, and thus make a measurable contribution to the ion current in equation (5). The upper limit is also restricted by the growth in the effective cross section described in equation (4), which is associated with a reduction in the spatial resolution and an increase in the electrostatic load on the environment. The upper limit, which is justified by resolution of small space potentials and the physical resolution of the probe, for the sensor potentials may be chosen as required for the purposes of expedient achievement of a measurement object.

The probe for characterization of the electrostatic state in gases may be used for the following five objectives:

1 Determination of the space potential in unknown ion densities from two sensor currents with the same mathematical sign, with one main sensor potential and one auxiliary potential,

2. Determination of the space potential and of the density of ions of one polarity from two sensor currents with the same mathematical sign, with one main sensor potential and one auxiliary potential,

3. Determination of the ion densities with a known space potential from the two sensor currents with opposite mathematical signs, with two main sensor potentials,

4. Determination of the space potential and ion densities in an integrated method comprising three sensor currents with two main sensor potentials, with currents of opposite mathematical signs and one auxiliary potential,

5. Determination of the effective cross section of the probe as a function of the measurement parameters.

Any desired auxiliary potential U(h) whose sensor current has a value which can be measured considerably better than the system inaccuracy is now first of all applied in order to determine the space patential. Depending on the mathematical sign of the sensor current that occurs, equation (5) is applicable to this, as follows:

−i(h+)=4πeRk⁺N⁺(U(h−)−Uᵣ); −i(h−)=4πeRk⁻N⁻(U(h+)−Uᵣ) (10a,b)

A sensor current is then measured using a main sensor potential whose sensor current has the same mathematical sign but is considerably greater than that measured with the previously applied auxiliary potential. The ion densities, which are still unknown, can now be eliminated from equations (5) and (10) and the space potential can be calculated:

$${U}^{-} = 1 - \frac{i ( h + )}{i ( + )} ; {U}^{+} = 1 - \frac{i ( h - )}{i ( - )} \qquad \text{(11a,b)}$$

Equation (a) applies when positive sensor currents occur. Equation (b) applies in a corresponding manner for negative sensor currents.

The ion densities can now be determined, with a known space potential, using equation (5) from two permissible sensor currents with opposite mathematical signs, and with two appropriately adapted main sensor potentials. Solving on the basis of the ion densities results in:

$${N}^{+} = \frac{- i ( + )}{4 π \cdot {ek}^{+} R ( {U}^{-} - {U}_{r} )} : {N}^{-} = \frac{- i ( - )}{4 π \cdot {ek}^{-} R ( {U}^{+} - {U}_{r} )} \qquad \text{(12a,b)}$$

When determining the space potential and ion densities using an integrated method, the ion densities can be calculated directly from the three sensor currents for two main sensor potentials and one auxiliary potential, by substitution of equation (11) in (12). When a positive sensor current i(h+) occurs:

$${N}^{+} = - \frac{i ( + )}{4 π \cdot {ek}^{+} {RU}^{-}} ( \frac{1 - \frac{i ( h + )}{i ( + )}}{1 - \frac{U ( h - )}{{U}^{-}}} ) ; \\ {N}^{-} = - \frac{i ( - )}{4 π \cdot {ek}^{-} {RU}^{+}} ( \frac{1 - \frac{i ( h + )}{i ( + )}}{( 1 - \frac{U ( h - )}{{U}^{+}} ) + \frac{i ( h + )}{i ( + )} ( \frac{{U}^{-}}{{U}^{+}} - 1 )} ) \qquad \text{(13a,b)}$$

and when a negative sensor current i(h−) occurs:

$${N}^{+} = - \frac{i ( + )}{4 π \cdot {ek}^{+} {RU}^{-}} ( \frac{1 - \frac{i ( h - )}{i ( - )}}{( 1 - \frac{U ( h + )}{{U}^{-}} ) + \frac{i ( h - )}{i ( - )} ( \frac{{U}^{-}}{{U}^{-}} - 1 )} ) ; \\ {N}^{-} = - \frac{i ( - )}{4 π \cdot {ek}^{-} {RU}^{+}} ( \frac{1 - \frac{i ( h - )}{i ( - )}}{1 - \frac{U ( h + )}{{U}^{+}}} ) \qquad \text{(14a,b)}$$

The terms in brackets describe the influence of the space potentials on the measurement of the ion densities, with the space potentials being characterized by the sensor currents associated with the auxiliary potentials. These will assume the value unity in the situation where no sensor current occurs when using the auxiliary potential with the value zero, that is to say where i(h−)=0 or i(h+)=0, potential equilibrium exists between the space and the sensor, and the space potential has the value Uᵣ=0. Equations (13) and (14) then change to the form of the simple Riecke formula from equation (1).

The electrostatic variables in gases need not be constant in three dimensions. The space potential and ion densities may be subject to locally major changes in the vicinity of sources. If one wishes to resolve the local effects more accurately at one field point, then the physical resolution of the measurement is restricted by the effective cross section of the probe. According to equation (4), the effective cross section for a given gas flow velocity and given sensor dimensions depends on the main sensor potential and the space potential. In a method according to the invention, the effective cross section may additionally be calculated for each measurement point. However, a desired upper limit value may also be preset for the effective cross section, and an upper limit value for the sensor currents may be specified by substitution of the equation (4) in (5), and this could be monitored by the probe. The electrostatic state in the gas can thus be characterized by the measurement values for the space potential, the ion densities and the physical gradient using a standard method.

The described solution approach for characterization of the electrostatic state in gases with the determination of the space potential and of the ion densities, and of the effective cross section using a probe according to the invention has the following features:

1. The measurement variables are determined from sensor currents with different applied sensor potentials.

2. The sensor currents are subject to restrictions relating to their permissible value range. They are therefore monitored for compliance with their appropriate mathematical sign.

3. When sensor currents with unacceptable mathematical signs occur, the sensor potentials which are associated with them are changed until each associated sensor current assumes the permissible mathematical sign.

4 Space potentials are determined from two sensor currents with the same mathematical sign, with a main sensor potential and an auxiliary potential being applied in each case.

5. The density of ions with the same polarity as the mathematical sign of the sensor currents can also be evaluated from the sensor currents obtained when determining the space potential.

6. The densities of positive and negative ions for a known space potential are determined from two sensor currents with opposite mathematical signs, by applying two main sensor potentials.

7. If the space potential is not known, ion densities are determined from three sensor currents with at least one different mathematical sign, with two main sensor potentials and one auxiliary potential being applied.

8. If the flow velocity of the gas is known, the effective cross section is determined from the previously measured values.

9. In order to comply with a minimum sensitivity for the resolution of space potentials and for the spatial resolution of the measurement, upper limit values way be specified for the sensor currents, depending on the intended measurement task.

### REFINEMENT OF THE INVENTION

Developments of the invention relate to:

Simplification of the evaluation of the measurement variables by restrictions on the selection of sensor potentials,

Increasing the measurement sensitivity by adding to the validity criteria for the sensor currents and the definition ranges of the space potential by means of advantageous measurement ranges,

Monitoring of the undisturbed operation of the open sensor.

Using any desired number of combinations of main sensor potentials and auxiliary potentials for determining space potentials, practical examples for the restriction of the sensor potentials used are specified, which considerably simplify the evaluation of measurement variables using equations (11) to (14). Their use must be decided on the basis of the characteristics of the respective measurement task. The first restriction relates to the values of the main sensor potentials. If, for example, these are always chosen to have equal magnitudes with respect to the earth potential, and the convention

U⁻=−U⁺ (15)

is introduced a term in brackets in equations (13) and (14) is reduced to a factor of −2.

The calculation method is further simplified by means of three examples of conventions relating to the auxiliary potential to be used.

1. In the zero potential method, U(h0)=0 V is chosen as the value of the auxiliary potential. Further simplifications result both when using equation (11) to calculate the space potential and when using equation (13) or (14) to calculate the ion densities. It should now be remembered that equation (11a) and the equations (13a, 13b) can be used when a positive sensor current i(h0) occurs, and that equation (11b) and the equations (14a, 14b) can be used when a negative sensor current i(h0) occurs.

2. A further simplifying method example is the half potential method. This uses the convention:

U(h+)=½U⁺ or U(h−)=½U⁻ (16a,b)

with half the value of one of the main sensor potentials as the auxiliary potential. This also results in simplifications in the calculation equations (11), (13) and (14).

3. A third example for a simplified application of the auxiliary potential is the comparison method. In this case, an auxiliary potential with the value zero is applied, using equation (10) When a space potential is present, a sensor current occurs with the same mathematical sign as the space potential. If the auxiliary potential is now increased with the same mathematical sign, then the sensor current must decrease in the presence of a space potential with the same mathematical sign as the auxiliary potential, and must assume the value zero. The convention in this case is:

−i(h+)=0 for U(h−)=Uᵣ; −i(h−)=0 for U⁺=Uᵣ. (17a,b)

The mathematical sign and magnitude of the space potential are thus determined directly by comparison of the space potential with an auxiliary potential. The ion densities are now calculated by means of the simple calculation equations (12) with the aid of the known space potential from two sensor currents with two main sensor potentials of the same magnitude but with opposite mathematical signs and which, for example in the case of the half potential method, have twice the value of the auxiliary potential in equation 17.

The invention is further refined by maintaining minimum magnitudes in the differences between the sensor potentials and space potentials, thus achieving minimum magnitudes for sensor currents, in order to increase the measurement sensitivity. This is because, on the one hand, the sensor potentials in equations (5) and (10) must not be very high in comparison to the space potentials, since the influence of the space potentials on the sensor potentials then disappears, and space potentials cannot be resolved. On the other hand, the sensor currents are very small when the difference between the space potential and the sensor potential is very small. It the sensor currents are small, their relative accuracy decreases, and the influence of the system inaccuracy increases.

It is thus expedient to define a measurement range as well, in addition to the permissible value range of the sensor currents and the definition range of the space potentials, based on equations (6) to (9). In this case, the measurement range is chosen to be considerably smaller than the permissible definition range for the space potential. For example, using the simplifications mentioned above, the minimum separation between the space potential and the sensor potentials may be chosen to be 25% of the magnitude of the main sensor potentials, in order to define the measurement range:

$${U}^{+} < [ U ( h - ) - 0.25 {U}^{-} ] < {U}_{r} < 0.75 {U}^{+} ; \\ 0.75 {U}^{-} < {U}_{r} < [ U ( h + ) - 0.25 {U}^{+} ] < {U}^{+} \qquad \text{(18a,b)}$$

In this case, equation (18a) applies to a negative auxiliary potential, and equation (18b) to a positive auxiliary potential.

The criterion which is chosen in equation (18) for the measurement range can be applied only to a restricted extent to the zero potential method. U(h0)=0 V is a range for Uᵣ(−0.25U⁺<Uᵣ<−0.25U⁻) that is not covered in the value range around Uᵣ=0 V, and the predetermined measurement sensitivity is not reached in this area. This disadvantage of the zero potential method does not occur when using the half potential method. Equation (18) then assumes the following form:

0.75U⁻<Uᵣ<0.25U⁺ for U(h+); 0.25U⁻<Uᵣ<0.75U⁺ for U(h−) (19a,b).

Thus, in contrast to the zero potential method, the half potential method always provides a high measurement sensitivity in the region of small space potentials around Uᵣ=0 V. The difference between the sensor potential and the space potential, and hence the sensitivity, can be additionally improved when using the half potential method by also changing the mathematical sign of the auxiliary potential when the mathematical sign of the space potential changes. In principle, there is no difference between the auxiliary potential and the space potential in the comparison method, and the comparison method thus does not permit the use of measurement range limits for the determination of the space potential. It is thus impossible to achieve a measurement sensitivity that is comparable to that of the half potential method for the space potentials.

The restriction in the definition range for Uᵣ to a measurement range suitable for increasing the measurement sensitivity may be pursued even further than in the example described here. Restricting the measurement range to 50% instead of 25% as described would improve the separation from the system inaccuracy of the measurement apparatus by a further factor of two, for example with the half potential method and using main sensor potentials of the same magnitude. However, the interval for permissible values of the space potential without adaptation of a sensor potentials would then be reduced from the full magnitude of a sensor potential, to half this. In the extreme, the adaptation of the sensor potentials can be optimized for each space potential that occurs.

The third example for a refinement of the invention relates to the monitoring of the undisturbed operation of the open sensor. The physical description of its operation is based on the fact that the field strength which acts on the ions as a result of the applied potential decreases with 1/r² in comparison to free space. If this field is changed, for example by dielectric materials, disturbance potentials or earthed objects, within a circular area by disturbances that are located within about ten times the diameter of the sensor sizes the measurement variables which can be detected by the probe will not be able to be evaluated without errors. A measurement variable for the disturbance-free field, using equation (3), represents the capacitance of the sensor with respect to free, undisturbed space. The comparison of this capacitance with the capacitance subsequently measured via a capacitive measurement bridge during operation makes it possible to monitor undisturbed operation.

A probe according to the invention may be equipped with sensor heads with different dimensions in order to match the measurement sensitivity to the particular measurement tasks. The described measurement bridge may also carry out the function of identification of the different sensor heads via its capacitance, and may transmit the appropriate computation variable, for example the effective sensor radius R, to the evaluation unit.

### BRIEF DESCRIPTION OF THE DRAWINGS

The invention and preferred embodiments thereof are further explained with reference to the accompanying drawings, wherein

FIG. 1 shows the fields around a three dimensional sensor,

FIG. 2 shows measured sensor currents in an embodiment of the invention,

FIGS. 3(a) to (c) show sensor currents, ion densities and space potentials obtained with a conventional CPM and with an embodiment of the invention,

FIG. 4 shows sensor currents and ion densities obtained with an embodiment of the invention, and

FIG. 5 shows an apparatus for measuring space potential, ion density and effective cross sectio, as an embodiment of the invention.

### DETAILED DESCRIPTION OF PREFERRED EMBODIMENTS

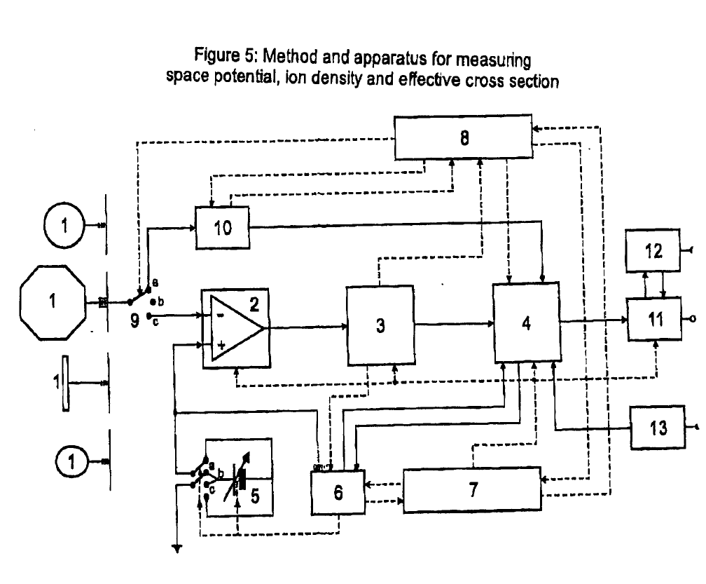

The method as derived from theoretical analyses in equations (4) to (17) has been checked in three experiments with embodiments of the invention. Measurements were carried out in a clean room with an air ionization system. An air ionization system with pointed electrodes at high voltage was used as the ion source. A measurement apparatus (probe) according to an embodiment of the invention and as explained later in connection with FIG. 5 was used to measure the sensor currents for main sensor voltages with positive and negative mathematical signs, and, for the auxiliary potential, with the value zero.

FIG. 2 shows the relationship between the sensor currents i(+), i(−) and i(0) and the space potential Uᵣ determined from equation (11) by the zero potential method. The illustration is supplemented by explanatory notes, which indicate the method for determining space potentials.

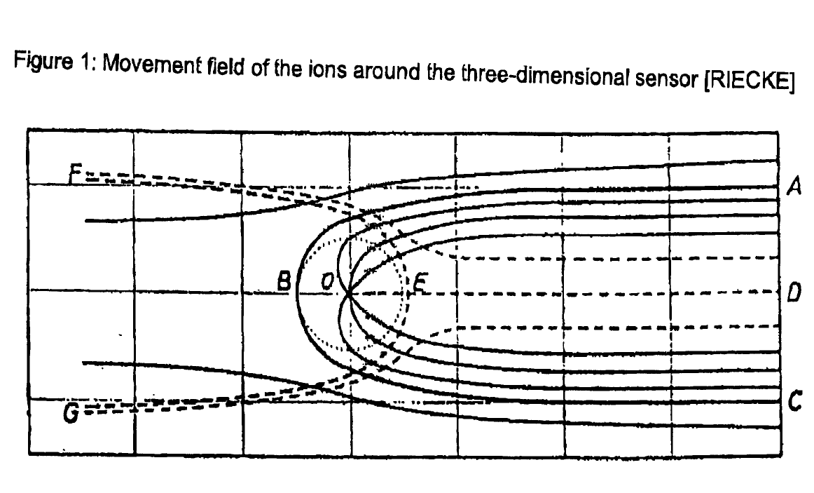

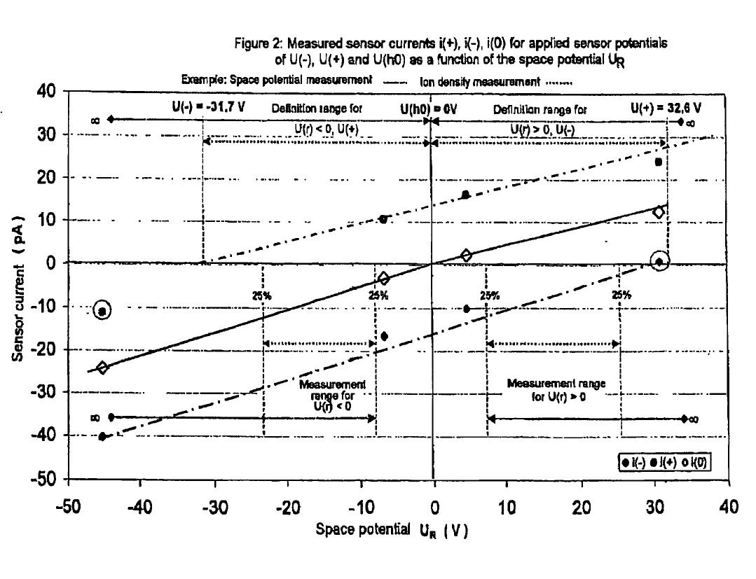

As expected, the sensor currents change their mathematical signs on reaching the limits of their permissible value range. At this point, the associated space potential has the same value as the corresponding main sensor potential. The potential U⁺−Uᵣ or U⁻−Uᵣ which acts on the ions in the incident flow area of the sensor as shown in FIG. 1 assumes the value zero in accordance with equation (5). The measured sensor currents are identified by circles, although these cannot be evaluated since they are outside the permissible value range. The sensor current i(0) which is associated with the applied auxiliary potential changes its mathematical sign when the space potential assumes the same value as the auxiliary potential, namely the value zero. In addition to the mathematical sign, the trend line i(0) also changes in gradient, as is to be expected from equation (9) owing to the different ion densities of positive and negative ion densities, and to the different ion mobilities.

FIG. 2 shows the definition ranges for Uᵣ, which are bounded on one side in each case in accordance with equation (7), for the determination of space potentials. The same equation results in a second boundary for the definition range, for determining the densities of positive and negative ions. Compliance with the definition range is a necessary condition for the operation of the probe. If the definition range limits are exceeded, then the measured sensor current changes its mathematical sign in the process. The evaluation must be interrupted, and the magnitudes of the main sensor potentials must be increased until the sensor currents are once again within their permissible value range.

No change in the mathematical sign of the sensor currents is associated with the reaching of the boundary of the measurement ranges, which are likewise illustrated. For this reason, the range limits must be monitored by means of a voltage comparison. Compliance with the measurement ranges is not a necessary condition for the validity of the measurement values. The magnitude of the main sensor potentials may be continuously adjusted if the measurement range limits are reached.

If the definition and/or measurement range limits are permanently undershot, on the other hand, the main sensor potentials should be reduced, in order to take account of the advantage according to the invention of high resolution of space potentials and small effective cross sections.

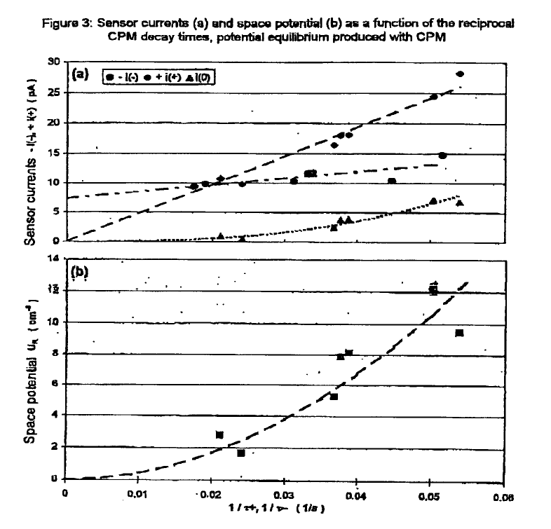

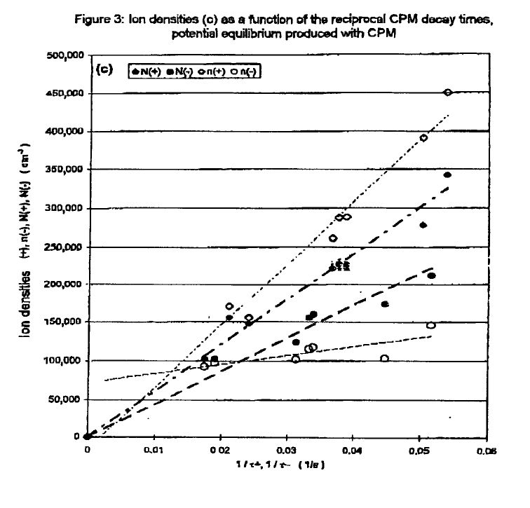

In a second measurement, the air ionization system was adjusted such that the density of positive and negative ions was increased in steps in such a way that the CPM in each case indicated a space potential with the value 0 in this case. For comparison with the probe according to the invention, the reciprocal decay time of the CPM was used as a measure of its sensor current FIG. 3 (a) shows the use of the probe taking into account the condition for the expedient measurement range. The sensor current i(+) with a negative sensor potential has a positive mathematical sign owing to the positive ions that are absorbed, and i(−) has a negative mathematical sign in a corresponding way. Since the measured sensor currents do not change their mathematical signs, the permissible measurement range has been complied with. In contrast to the trend line for the sensor current i(+) triggered by positive ions, the trend line for i(−) does not run through the zero point, as would be expected from the simple Riecke formula in equation (1). This is due to the space potentials which are not taken into account there.

These are evaluated in FIG. 3b using the zero potential method. The method according to the invention finds space potentials, even though the CPM was set to a space potential of zero. The amperometric probe obviously assesses the space potential differently to the potentiostatic method used by the CPM. The trend line was predetermined using a square-function relationship. The measurement points follow the profile of the trend line. This indicates a systematic discrepancy in the assessment of the space potential. As, in contrast to the CPM, the probe has a closed physical description, checked experimentally, and a standard measurement method was used, it is assumed that the assessment by the probe is the appropriate one. The measured space potential is positive, as expected from the positive mathematical sign of i(h0) based on equation (9).

In FIG. 3c, the ion densities n⁺ and n⁻ are evaluated on the basis of the simple Riecke formula (1), and the ion densities N⁺ and N⁻ are evaluated on the basis of the extended Riecke formula (12), as well as (13) and (14). The measurement results confirm that only the use of the extended Riecke formula confirms the theory on which this is based, since the trend line for n⁻ does not pass through the zero point, and the trend lines for N⁺ and N⁻ are confirmed by the amperometric reference method using the CPM.

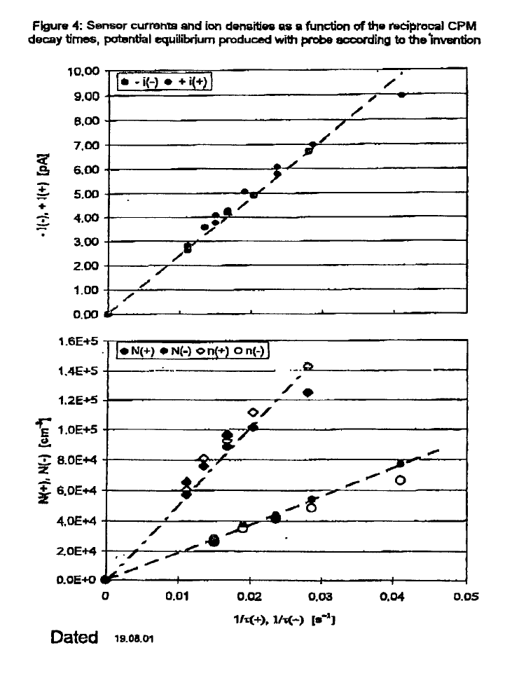

FIG. 4 shows the measurement results which are comparable with those in FIG. 3, with the special feature that the ion sources in the clean-room system have now been adjusted to the potential equilibrium with Uᵣ=0 and i(0)=0 using the zero potential method with the probe rather than using the CPM. In these specific potential equilibrium conditions, the extended Riecke formulae (12) as well as (13) and (14) are reduced to the simple Riecke formula (1), and this is confirmed by the measurements in the trend curves for the ion currents and the ion densities.

A method and an apparatus according to the invention can be described on the basis of the described solution approach to the previously defined object. Method steps for measurement of ion densities and of the space potential, as well as for defining the effective cross section in an embodiment of the invention, are as follows:

1. Selection of a sensor 1 (see FIG. 5) whose size corresponds to the requirements for the system sensitivity

2. Determination of the effective radius R of the three-dimensional sensor using equation (1) by means of a measurement bridge 10, and storage of the measurement value in a calculation unit 4

3. Application of a first sensor potential (auxiliary potential) to the sensor 1 from a potential source 5, controlled by a measurement control unit 7 via a potential adjustment unit 6

4. Detection of the associated first sensor current in a current detection unit 2

5. Storage of the first sensor current and of the first sensor potential (auxiliary potential) in the calculation unit 4

6. Application of a second sensor potential by means of the potential adjustment unit 6, controlled via the measurement control unit 7

7. Detection of the second sensor current in the current detection unit 2

8. Assessment of the permissibility of the second sensor current based on the mathematical sign and magnitude, in a current assessment unit 3

9. If the mathematical sign of the sensor current is not permissible, adaptation of the second sensor potential until a permissible second sensor current occurs with the same mathematical sign as and higher magnitude than the first sensor current and, associated with this, reaching of the main sensor potential that is associated with the auxiliary potential, by means of the current assessment unit 3 and the potential adjustment unit 6

10. Detection and storage of the second permissible sensor current and of the associated main sensor potential in the calculation unit 4

11. Calculation of the space potential from the two sensor currents and from the two sensor potentials in the calculation unit 4

12. Storage of the space potential in the calculation unit 4

13. Application of a third sensor potential by means of the potential adjustment unit 6, controlled via the measurement control unit 7

14. Detection of the third sensor current in the current detection unit 2

15. Assessment of the permissibility of the third sensor current in the current assessment unit 3

16. If the mathematical sign of the third sensor current is not permissible, adaptation of the third sensor potential until a permissible third sensor current occurs with the opposite mathematical sign to the first sensor current and, associated with this, reaching of the corresponding main sensor potential by means of the current assessment unit 3 and the potential adjustment unit 6

17. Storage of the third permissible sensor current and of the associated main sensor potential in the calculation unit 4

18. Determination of the ion densities from the sensor currents and from the sensor potentials, and storage of the results in the calculation unit 4

19. Input of the flow velocity of the gas via an input unit 13

20. Calculation of the effective cross section of the probe in the calculation unit 4

21. Indication and/or output of the measurement results in a transfer unit 11

The method can be supplemented by the following refinements of the invention:

22. Determination of the density of ions of one polarity from the stored space potential and from the main sensor potential associated with the auxiliary potential, and from the associated sensor current, in the calculation unit 4

23. Simplification of the evaluation in the calculation unit 4

a. by selection of main sensor potentials of the same magnitude from the potential source 5

b. by selection of the auxiliary potential with half the magnitude of the main sensor potential with the same mathematical sign, by means of the potential adjustment unit 6 and the potential source 5

c. by selection of the auxiliary potential with the value zero

d. by determination of the space potential as that value of the auxiliary potential, changed by the potential adjustment unit 6, at which the associated sensor current, as assessed by the current assessment unit 3, assumes the value zero

e. by determination of the ion densities using the stored space potential and the two main sensor potentials as well as the sensor currents associated with them

24. Increasing the measurement sensitivity

a. by matching the main sensor potentials to the order of magnitude of the space potentials that occur, by voltage comparison in the potential adjustment unit 6

b. by use of the half potential method, controlled by the measurement control unit 7 and the potential adjustment unit 6

c. by controlling the mathematical sign of auxiliary potentials by voltage comparison in the potential adjustment unit 6 such that they have the opposite mathematical sign to the space potential

d. by introducing measurement ranges by means of voltage comparison of the space potentials with the sensor potentials and by raising the sensor potentials if the minimum separations between the space potential and the sensor potential are undershot, in the potential adjustment unit 6

25. Compliance with minimum values for the effective cross section by means of voltage comparison of the sensor potentials with an upper limit value and possible reduction of the sensor potentials by voltage comparison in the potential adjustment unit 6

26. Monitoring of the undisturbed operation of the open sensor by means of the capacitive measurement bridge 10 with limit-value monitoring by means of capacitance comparison

27. Identification of different, interchangeable sensor heads by capacitance comparison by means of the capacitance measurement bridge 10, with the applicable dimension value, for example the effective radius R, being passed on to the calculation unit 4

28. Preselection, of possible measurement programs such as the space potential or space potential and ion densities, or ion densities, in the measurement control unit 7

29. Selection and passing through a warming-up phase in measurement conditions, controlled by a monitoring control unit 8, with the current drift compensation being stabilized in a known manner and the sensor currents being detected in the current detection unit 2, with the sensor currents then being assessed in the current assessment unit 3, and the sensor potentials being matched to the measurement task by means of the potential adjustment unit

30. Switching to the measurement mode by the monitoring control unit 8 and transfer of control to the measurement control unit 7, clocking of the current detection unit 2, of the current comparison unit, of the calculation unit 4 and of the potential adjustment unit 6 in accordance with the preselected measurement programs

31. Determination of the actual effective cross section of the probe based on a previous input of the effective flow velocity of the gas via the input unit 13, and storage of the value in the calculation unit 4

32. Indication of the values for the actual potentials, for example in the potential adjustment unit 6, to be precise for the

a. main sensor and auxiliary potentials

b. space potential

33. Manual preselection of the measurement ranges for example on the potential adjustment unit 6 for appropriate adaptation of the sensor potentials

34. Limit value signalling device 12 for the space potential, for the density of negative and positive ions and for the effective cross section of the sensor, by comparison with preselected and entered range limits.

An apparatus (probe) according to an embodiment of the invention is illustrated schematically in FIG. 5, and is composed of the following major components:

1. Any desired open sensor 1 equipped with a sensor head for application of any desired variable sensor potentials with respect to earth potential, with the size suitable for adaptation of the measurement sensitivity,

a. of any desired configuration,

b. sensor in the form of a plate,

c. three-dimensional sensor with an effective radius R which is determined capacitively,

d. spherical sensor,

e. sensor in the form of a point, for example a wire end,

f. a set of different sensor heads, which are interchangeable for matching to the measurement task and can be identified by means of a capacitive measurement bridge,

2. A current detection unit 2, connected downstream from the sensor, for detection of the sensor currents,

3. A current assessment unit 3, connected downstream from the current detection unit, for detection of the mathematical sign of the sensor currents and for carrying out current comparisons for analysis of compliance with permissible values for the sensor current, with outputs for passing on the value of the sensor current to the downstream calculation unit 4, for passing on the information about the mathematical sign of the sensor current to the potential adjustment unit 6 in order to achieve matching of the sensor potentials to permissible sensor currents via the potential source 5, and for passing on the information about non-compliance with the permissible value range to the monitoring control unit 8,

4. A calculation unit 4 for calculation of the space potential, ion densities and effective cross section, in which the influence of the space potential on the measurement results is taken into account in the calculation, and to which information is supplied about the sensor currents, about the actual sensor potentials, about the flow velocity of the gas at that time, and about the effective radius of the probe, and which transfers the space potential to the potential adjustment unit 6 in order to carry out a voltage comparison, and transfers the evaluated measurement variables to the output unit 11,

5. A potential source 5 for applied sensor potentials which can be adapted as required, preferably in a magnitude range from 0 to +/−100 volts, which, controlled by information from the potential adjustment unit 6 and, clocked by this via the measurement control unit 7, sequentially

a. emits an auxiliary potential and a main sensor potential with the same mathematical signs for measurement of space potentials and of the density of ions of one polarity,

b. emits an auxiliary potential and two main sensor potentials with opposite mathematical signs for determining the space potential and ion densities,

c. emits two main sensor potentials with opposite mathematical signs for determining ion densities with a known space potential,

d. which, as the auxiliary potential, emits half the value of the main potential,

e. emits the auxiliary potentials with the opposite mathematical signs of the space potential

f. which emits an auxiliary potential with the value zero,

g. which emits main sensor potentials with the same magnitude,

6. A potential adjustment unit 6 for controlling the matching of the sensor potentials and for passing on the actual voltage values to the calculation unit 4, if necessary provided with an indication of the actual sensor potentials and of the space potential, and with a capability to preselect the sensor potentials in order to define measurement ranges, and with a voltage comparison unit, self-actuated

a. by the measurement control unit 7 for the timing of the measurement sequences,

b. by the current comparison unit 3 when sensor currents which are not permissible occur,

c. by its own voltage comparison unit for comparison of the space potential as determined in the calculation unit 4 with the actual sensor potential in order to check for compliance with the preselected measurement range,

d. by its own voltage comparison unit for comparison of the mathematical sign of the space potential with the mathematical sign of the auxiliary potential, and for switching to the opposite mathematical sign for the space potential,

7. A “measurement control unit”, programmed with predetermined measurement sequences, for controlling the respectively, selected measurement program by direct clocking

a. of the sensor currents in the current detection unit 2,

b. of the current comparison unit 3,

c. of the calculation unit 4,

d. of the sensor potentials via the potential adjustment unit 6 and the potential source 5,

e. of the evaluation unit 11, and by indirect clocking via the monitoring control unit 8

f. of the monitoring switch 9 and

g. of the capacitive measurement bridge 10,

8. A monitoring control unit 8 with functions such as monitoring of the current drift in the warming-up phase and during operation, and with additional functions, such as

a. monitoring for compliance with the permissible value ranges at the output of the current assessment unit 3 for the duration of the adaptation of the sensor potentials when the sensor currents are not permissible,

b. identification of different sensor heads via the capacitive measurement bridge 10,

c. monitoring of the undisturbed operation of the open sensor 1 via the capacitive measurement bridge 10 in the measurement mode,

with the evaluation of the measurement variables in the calculation unit 8 being interrupted in the operating mode, and with critical measurement values being passed on as an error record, instead of the measurement variables, to the transfer unit 11,

9. A monitoring switch 9, associated with the monitoring control unit 8, in this case represented by the functions:

a. monitoring of disturbance-free operation of the sensor 1 or its identification,

b. detection of the drift component for appropriate compensation for the sensor currents,

c. measurement of the sensor currents for matching to the permissible value range,

with the measurement of the sensor currents also being carried out in the basic setting (c) in the measurement mode, which is controlled via the measurement control unit 7,

10. A capacitive measurement bridge 10, provided with a comparison unit for capacitances, and with a memory for actual and predetermined fixed capacitance values of the various sensor heads, for

a. monitoring of the operation of the open “sensor” 1 during continuous operation with limit value signalling indirectly controlled by the measurement control unit 7 or controlled directly within the monitoring cycle by the monitoring control unit 8 with switching to the operating function of the monitoring control unit 3 in the event of disturbances,

b. identification of the sensor heads 1, with the measurement variables which are applicable to the evaluation, such as the capacitance C or the effective radius R, being passed on to the memory in the calculation unit 8,

11. An output unit 11 for indication and/or for passing on the measurement results via an interface for example to a central computer,

12. A limit value signalling device 12 for the measurement variables,

13. An input unit 13, for example for the velocity of the gas in the vicinity of the sensor 1 for passing on to the memory in the calculation unit 8.

Advantages of the Potential Probe of the Embodiments Over the Prior Art:

Against the background of the present investigations, the CPM could also be regarded as a probe for determining space potentials and ion densities. In comparison to the amperometric method of the probe according to the embodiments, the potential would be determined using a potentiostatic method, which leads to different results in the assessment of the space potentials. In contrast, as is shown in FIGS. 3 and 4, except for an unknown factor, the reciprocal decay times behave in the same way as the ion densities determined using the method according to the embodiments. These are obviously comparable methods for assessment of ion densities. The space potential therefore has no influence on the reciprocal decay times as on the sensor currents in FIGS. 2 and 3, since the potentials at the CPM, which correspond to the main sensor potentials, are approximately 30 times greater than the very much lower probe potentials.

The use of different methods for determining space potentials and ion densities in the CPM has the disadvantage that the different sensor potentials for the space potential and ion density as the two variables result in different effective cross sections being used for assessment of the results. In consequence, no comparable volumes of the measurement samples are predetermined for the two variables when using the CPM for measurement. Thus, cross sections which differ by several orders of magnitude are used for assessment of the measurement variables. Furthermore, only characteristic figures described by a standard convention can be specified for the ion densities by means of the decay times since no physical description is available, such as the extended Riecke formula. A probe according to the embodiments thus has the following advantages:

The space potential and ion densities are determined using a standard, physically described method with comparable spatial resolution of the measurement results.

The ion densities may be quoted as universally defined physical variables

The probe evaluates the effective cross section as a function of the measurement conditions, based on actual characteristics.

The spatial resolution of the measurement of ion densities, assessed as the effective cross section of the probe, amounts to about 15-30 cm² in the described measurement conditions with comparable sensitivity based on an estimate from equation (2) and is thus less than for the CPM by a factor of about 350 for assessment of the area or by a factor of about 20 for assessment of the diameter.

The spatial resolution of the measurement of space potentials, assessed as the effective cross section of the probe, is identical to that of the ion densities in the described measurement conditions and with comparable sensitivity due to the use of identical methods and, based on an estimate from equation (2), is less than for the CPM by a factor of about 7-15 for assessment of the area or by a factor of about 2.5-4 for assessment of the diameter.

The physical areas in which the potential of the open sensor can have a disturbing effect on products are reduced in the same ratio.

This low disturbance potential, the small dimensions and the automatic monitoring function of the open sensor make it possible, in contrast to the CPM, to use the probe for automated and computer-aided electrostatic monitoring of production processes without any disturbance to the electrostatic conditions.

The same characteristics allow the use of the probe in “mini-environments” and in closed process chambers.

The probe and the CPM assess ion densities identically in comparable measurement conditions, except for a calibration factor. After appropriate calibration, the probe can therefore calculate and output decay times which are analogous to the CPM, thus creating a link to the existing standard convention.

The measurement results are largely independent of the velocity of the laminar gas flow.

According to the claim in German Patent Specification DE 42 31 905 C2, this relates to a probe for determining ion densities. As found by measurements here, the described teaching relating to the use of fixed sensor potentials and ignoring the prevailing space potentials does not lead to the aim. Permissible value ranges for the sensor currents or definition ranges are not complied with and, furthermore, sensor currents are evaluated incorrectly. The two disadvantages which have been mentioned occur invariably except in the special situation of potential equilibrium, in which the space potential actually assumes the value zero. This is the only situation in which the simple Riecke formula and the extended Riecke formula have the same form, as is shown by a comparison of equation (5) with equation (1). Based on the knowledge disclosed here, this restriction can be overcome by choosing the sensor potentials to be sufficiently large, with a factor of 30-100 in comparison to the space potentials, that the influence on the probe currents in equation (5) disappears. With the characteristics of the experiment as illustrated in FIG. 2 with the sensor currents that are not permissible and at space potentials up to 40 volts, sensor voltages of more than 1000 volts would need to be applied for this purpose, which would completely destroy the advantage of small effective cross sections and high resolution of small space potentials in the event of a small disturbance in the vicinity. Apart from this, although the main claim requires a sensor current measurement at a fixed sensor potential of zero, the description is still dependent on the processing of the measured sensor current to form a measurement result. The probe according to the embodiments thus has the following advantages over the German Patent Specification:

The method allows the determination of space potentials.

The method allows compliance with small effective cross sections by using sensor potentials in the same order of magnitude as the space potentials.

The method for evaluation of ion densities takes account of the effect of the space potentials on the ion currents, and can thus be applied to special cases, without any restriction.

Due to the use of variable sensor potentials, the apparatus allows compliance with definition ranges and measurement ranges for the sensor currents, which are dependent on the respectively prevailing space potential.

The sensitivity of the probe or its spatial resolution can be improved by

The use of other sensor dimensions,

Other sensor potentials, and

The use of the half potential method according to the embodiments, with a limited measurement range in comparison to the described measurement results by a further factor of more than ten, with the half potential method on its own allowing a factor of more than five to be expected

The spatial resolution of the probe, which depends on the varying measurement conditions, can be evaluated as an effective cross section at the time.

The undisturbed operation of the open potential probe can be monitored automatically.

The method is not restricted to the use of a sphere as the sensor head.

1. A method for determining at least one electrostatic state variable in flowing gases which contain ions, using an amperometric probe in which a sensor is introduced into the gas flow and has a first potential applied to it, and a first sensor current which is caused by absorption of ions is measured and to which a second potential is applied and a second sensor current is measured, with the second potential being set such that the mathematical sign of the second sensor current is the same as that of the first sensor current, at which point the space potential is determined as an electrostatic state variable from the two potentials and from the two sensor currents.

2. A method according to claim 1, characterized in that a third sensor current is measured with a third potential applied to the sensor, with the third sensor potential being set such that the third sensor current has the opposite mathematical sign to the first and second sensor currents, and in that the densities of the positive and negative ions are calculated as further electrostatic state variables from the space potential or from the first sensor potential with the associated sensor current, and from the second and third sensor potentials and sensor currents.

3. A method according to claim 1, characterized in that the second sensor potential is adapted such that the magnitude of the second sensor current is greater than that of the first sensor current.

4. A method according to claim 1, characterized in that the mathematical sign and, possibly, the magnitude of the respective sensor currents are detected, and in that the respective potential is changed until the respectively changed sensor current satisfies said conditions on the mathematical sign.

5. A method according to claim 2, characterized in that the third potential which is applied to the sensor is chosen such that it has the opposite mathematical sign to the mathematical sign of the second potential.

6. A method according to claim 2, characterized in that, in order to simplify the process of determining the ion densities, the second and third potentials are chosen to have equal magnitudes, with respect to earth potential.

7. A method according to claim 1, characterized in that, in order to simplify the process of determining the space potential and/or the ion density, the first potential is chosen to be 0 V with respect to earth potential.

8. A method according to claim 1, characterized in that, in order to simplify the process of determining the space potential and/or the ion density, twice the value of the first potential, with respect to earth potential, is chosen as the second potential.

9. A method according to claim 1, characterized in that the first potential is set to 0 V with respect to earth potential, and the first sensor current is measured, and in that the first sensor potential is then changed until the first sensor current assumes the value zero, with the changed value of the sensor potential corresponding to the space potential.

10. A method according to claim 2, characterized in that, in order to determine the ion densities, two potentials, preferably of the same magnitude but with different mathematical signs, are applied, and the sensor currents are measured, which are used together with the space potential for determination.

11. A method according to claim 1, characterized in that the capacitance of the exposed sensor in free space is measured, and the effective radius of the sensor is determined using the dielectric constant.

12. A method according to claim 1, characterized in that the effective cross sections F⁺ and F⁻, respectively, of the sensor for positive and negative ions are determined for a known gas flow velocity v as:
$${F}^{+} = \frac{- 4 π \cdot {k}^{+} \cdot R \cdot ( {U}^{-} - {U}_{r} )}{v} {F}^{-} = \frac{4 π \cdot {k}^{-} \cdot R \cdot ( {U}^{+} - {U}_{r} )}{v}$$
where Uᵣ is the base potential, R is the effective radius of the sensor, k⁺, k⁻ are the mobility of the positive and negative ions respectively, and U⁻ is, seen relatively, the lower sensor potential or a negative sensor potential with respect to earth potential, and U⁺, seen relatively, is the higher sensor potential, or a sensor potential which is positive with respect to earth potential.

13. A device for determining at least one electrostatic state variable in flowing gases containing ions, with a three-dimensional exposed sensor, a potential adjustment apparatus for applying potentials to the sensor, a current detection apparatus for detecting sensor currents which are caused by absorption of ions when the potentials are applied, a current assessment apparatus for detecting the magnitude and the mathematical sign of the sensor currents and for monitoring the validity ranges for the sensor currents, and with a calculation apparatus for determining the space potential and/or the ion densities from the applied potentials and measured sensor currents as at least one electrostatic state variable.

14. A device according to claim 13, characterized in that the potential adjustment apparatus is connected to a control apparatus for controlling measurement sequences for determining the at least one electrostatic state variable.

15. A device according to claim 13, characterized in that the potential adjustment apparatus is set up to supply sequentially a first potential and then a second potential for application to the sensor in order to measure the space potential and/or the ion density, with the current assessment apparatus being set up to detect and compare the mathematical signs of the first and of the second sensor current and, if the mathematical signs do not match, to emit to the potential adjustment apparatus a signal to change the second potential, until the mathematical sign of the second sensor current corresponds to that of the first sensor current.

16. A device according to claim 15, characterized in that the calculation apparatus is set up to determine the space potential as a function of the first and of the second potential, and of the first and of the second sensor current.

17. A device according to claim 15, characterized in that the current assessment apparatus is set up to compare the magnitude of the two detected sensor currents.

18. A device according to claim 17, characterized in that the potential adjustment apparatus is set up to change the second sensor potential as a function of the result of the current comparison, in such a way that the magnitude of the second sensor current is greater than that of the first sensor current.

19. A device according to claim 15, characterized in that the potential adjustment apparatus is set up to supply a third potential for application to the sensor, with the current assessment apparatus being set up to check the mathematical sign of the detected third sensor current and, if necessary, to supply the potential adjustment apparatus with a signal to change the third potential, until the third sensor current satisfies a mathematical sign condition, the calculation apparatus being set up to determine the ion densities as a function of the three sensor potentials and of the three sensor currents.

20. A device according to claim 19, characterized in that the current assessment apparatus is set up to check compliance with the mathematical sign condition of the third sensor current, in such a way that the mathematical sign of the third sensor current is the opposite of the mathematical sign of the first and second sensor currents.

21. A device according to claim 13, characterized in that the current assessment apparatus is set up to act on the potential adjustment apparatus in such a way that the measured sensor current is positive when the applied potential is negative with respect to earth potential, and is negative when the applied potential is positive with respect to earth potential.

22. A device according to claim 13, characterized in that a measurement apparatus is provided for measuring the capacitance of the sensor.

23. A device according to claim 22, characterized in that the calculation apparatus is set up to determine an effective radius corresponding to R=C/4πε₀ from the capacitance of the sensor.

24. A device according to claims 13, characterized in that a number of sensors of different shapes are provided for selection, in that the measurement apparatus for measuring the capacitance has a memory unit for storing the capacitances of the number of sensors and, in order to identify the nature of the sensor, the measurement apparatus compares the measured capacitance with the stored capacitances.

25. A device according to claim 13, characterized in that a measurement apparatus is provided, having a capacitance comparison unit which monitors correct operation of the sensor during operation via the capacitance of the sensor.

26. A device according to claim 13, characterized in that the sensor is spherical, in the form of a point, ellipsoid, polyhedral or in the form of a plate.

27. A device according to claim 13, characterized in that the potential adjustment apparatus is equipped with a voltage comparison unit, in order to monitor compliance with advantageous measurement ranges independently of the monitoring of the mathematical sign conditions of the sensor currents by means of the current assessment apparatus, and to control appropriate adaptation of the sensor potentials by comparison of the space potential, which is determined by the calculation apparatus, with the respectively applied sensor potentials.
